(19) United States
(12) Patent Application Publication
(10) Pub. No.: US 2026/0038941 A1
(43) Pub. Date: Feb. 5, 2026

(54) Modular Battery Frame Assembly

(71) Applicant: Lithos Energy, Inc., San Rafael, CA (US)

(72) Inventors: Robert Wayne Sweney, Oakland, CA (US); Colin Haag, Columbus, OH (US); Dennis Lauguico, Burnaby (CA); Greg Nichols, Lafayette, CA (US); James Meredith, Mill Valley, CA (US)

(21) Appl. No.: 18/790,922

(22) Filed: Jul. 31, 2024

(51) Int. Cl. H01M 50/258; H01M 50/262; H01M 50/269

(52) U.S. Cl. CPC H01M 50/258; H01M 50/262; H01M 50/269

(57) ABSTRACT

A modular battery frame is disclosed. The modular battery frame includes one or more frame blocks and scaffolds to which the frame blocks attach. Each frame block includes individual battery cell frames and electrical collectors. The individual frame blocks are connected to one another. The collectors to electrically connect battery cells and the battery cells in frame blocks. The size of the modular battery frame is modifiable by changing the length of the scaffolds, to accommodate a predetermined number of frame blocks. The frame blocks are modifiable. The disclosure also provides a battery module. The battery cells are housed in the individual battery cell frames and connect to the collectors. The scaffolds attach to the frame blocks. The battery module also includes a battery management system positioned on a frame block. The voltage and capacity of the battery module are modifiable by changing the length of the scaffold profiles.

### TECHNICAL FIELD

This disclosure relates to frames for battery modules and to methods for the construction of battery modules.

### BACKGROUND

A battery module is a group of individual battery cells that are electrically connected and encased in a housing. They are the building blocks of larger battery packs, which are used in a wide variety of applications, from electronics and power tools to electric vehicles and grid storage. Frames are used to organize the battery cells and hold them in place. Frames also provide the scaffolding for the electrical connection between the battery cells.

### SUMMARY

In a first aspect, the disclosure provides a modular battery frame. The modular battery frame includes one or more frame blocks and scaffolds to which the frame blocks attach. Each frame block includes individual battery cell frames and electrical collectors. The individual frame blocks are connected to one another. The collectors to electrically connect battery cells and the battery cells in frame blocks. The size of the modular battery frame is modifiable by changing the length of the scaffolds, to accommodate a predetermined number of frame blocks.

The frame blocks are modifiable. In some implementations, the individual battery cell frames within each frame block are arranged in rows of between four and sixteen individual battery cell frames. In some implementations, each frame block comprises between four and sixteen rows. In some implementations, each frame block comprises eight rows of twelve individual battery cell frames.

The scaffolds attach to the frame blocks with fasteners.

The battery module frame of claim 1, wherein the frame blocks attach to the scaffold profiles on a track system.

The collectors are configurable in multiple configurations.

The collectors are connected to create specific configurations for use in specific applications.

In a second aspect, the disclosure provides a battery module. The battery module includes frame blocks, battery cells, and scaffolds. The frame blocks include individual battery cell frames connected to one another and collectors. The battery cells are housed in the individual battery cell frames and connect to the collectors. The scaffolds attach to the frame blocks. The battery module also includes a battery management system positioned on a frame block. The voltage and capacity of the battery module are modifiable by changing the length of the scaffold profiles.

In some implementations, the voltage and capacity of the battery module are configurable by modifying the connections between the battery cells. In some implementations, the voltage and capacity of the battery module are configurable by modifying the number of frame blocks in the battery module. In some implementations, the voltage and capacity of the battery module are configurable by modifying the manner in which the battery cells are aggregated.

In a third aspect, the disclosure provides a method for producing a battery module. The method includes providing a battery module frame. The battery module frame includes frame blocks. The frame blocks include individual battery cell frames connected to one another and collectors to electrically connect to and aggregate battery cells. The battery cells are placed in the individual battery cell frames. The individual battery cells are connected to the collectors. The frame blocks are connected to scaffolds. The desired voltage and capacity are determined for the battery module. The appropriate number of frame blocks are connected together to provide the desired capacity and voltage.

The manner in which the collectors aggregate the battery cells is modified to provide the desired capacity, and voltage.

In some implementations, the individual battery cell frames within each frame block are arranged in rows of between four and sixteen individual battery cell frames. In some implementations, each frame block comprises between four and sixteen rows. In some implementations, each frame block comprises twelve rows of eight individual battery cell frames. In some implementations, the scaffolds are manufactured in lengths to correspond to a set number of frame blocks.

The specific capacity, and voltage of a battery module, is determined and a battery module is assembled by manufacturing the appropriate size cell block, inserting battery cells into frame blocks, and connecting the necessary number of frame blocks to scaffolds to reach the determined capacity and voltage of a battery module.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative, and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a perspective view of a modular battery frame with two frame blocks.

FIG. 2 is an exploded view of a modular battery frame with two frame blocks and with battery cells installed.

FIG. 3 is a top view of a portion of a modular batter frame.

FIG. 4 is a top view of a portion of a modular batter frame.

FIG. 5 is a perspective view of a modular battery frame with six frame blocks.

FIG. 6 is an exploded view of a modular battery frame with six frame blocks and with battery cells installed.

FIG. 7 is a top view of a portion of a modular batter frame.

FIG. 8 is a top perspective view of two modular battery frames attached together.

FIG. 9 is a top view of two modular battery frames attached together.

FIG. 10 is a front view of two modular battery frames attached together.

FIG. 11 is a front perspective view of two modular battery frames connected together.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “battery” is meant to refer to a device that stores chemical energy and converts it into electrical energy. A battery is made up of one or more electrochemical cells that use chemical reactions to produce electricity.

As used herein “regular shape” is meant to refer to a shape or a polygon in which all the sides are of equal length, and all the interior angles are equal. For example, a regular hexagon has six sides of equal lengths, and the interior angles are all one hundred and twenty degrees (120°).

Battery cells are grouped into modules for several reasons. One reason is to improve safety. By grouping the cells together, it is easier to contain any leakage of electrolyte. Additionally, any fire will be isolated into a smaller group. Further, modules can be equipped with sensors and controls that can help to prevent safety hazards. Another reason to group cells into modules is to improve efficiency. By connecting the cells in series, the voltage of the battery pack can be increased. By connecting the cells in parallel, the capacity of the battery pack can be increased. This allows battery packs to be tailored to the specific needs of an application. Grouping cells into modules can make them easier to manufacture and assemble. Modules can be pre-assembled and tested before being integrated into a larger battery pack. This can help to improve the quality and reliability of battery packs.

Battery cells are often cylindrical in shape. Cylindrical shapes for battery cells offer some advantages including good mechanical stability and ease of manufacture. The cylindrical shape distributes pressure evenly throughout the cell. This makes them structurally strong and able to withstand the buildup of internal pressure during operation. This is important for safety, as it reduces the risk of leaks or ruptures. Cylindrical cells are relatively simple to manufacture using automated processes. This makes them a cost-effective option, especially for mass production. The winding process for the electrodes within the cell is well-established and allows for consistent quality. The cylindrical shape allows for better air circulation around the cell, which helps to keep it cool. This is important because heat can degrade battery performance and lifespan. Cylindrical cells can better handle swelling caused by gas buildup during charging and discharging cycles.

However, disadvantages of cylinders include the necessity to provide a frame to hold the cylinders because a cylinder is less stable when positioned on one end. The electrodes are generally positioned at the top of the battery cell. Connections between the electrodes are therefore at the top of the of each battery cell. Movement at the top of the battery cells can lead to broken electrical connections. Most battery pack designs, and particularly those designed for cylindrical battery cells utilize adhesives or mechanical retention devices which are located away from the top of the battery cell. Adhesives are heavy, expensive, hard to control, and often have a slow cure time. All these detriments to adhesives affect the speed at which a battery pack is assembled. Mechanical retention away from the top of the cell, offers less mechanical rigidity to the top of the cell, which is detrimental because most of the electrical connections attach at the top of the cell, where the electrodes are positioned, if the battery cells are not held rigidly in place connections between the cells can be difficult to establish, or can be broken if the cells shift.

A frame can be used to hold the battery cells in place. Each battery cell requires its own frame, a battery cell holding frame. Each battery cell holding frame is constructed of a rigid top integrated with an enclosure which surrounds a cavity into which a battery cell fits. In some implementations, the enclosure is cylindrical. In some implementations, the enclosure includes multiple walls, the multiple walls include any number of walls. In some implementations, the frame has between three and ten side walls. In some of these implementations, the side walls are of equal lengths on the horizontal axis, creating regular shapes or regular polygons. In some implementations, the side walls are of different lengths on the horizontal axis. In some implementations, the frame may extend the full length of the battery cell. In some other implementations, the frame may be in two portions, an upper portion which encompasses and supports the top of a battery cell and a lower portion which encompasses and supports the bottom of the battery cell. In these implementations, the upper portion may be between one fourth the length of the battery cell and one half the length of the battery cell. In other implementations, the upper portion may be one third the length of the battery cells.

In some implementations, the battery cell holding frames are arranged in rows. In some implementations, the battery cell holding frames are arranged in rows of between three and sixteen battery cell holding frames. In some implementations, the rows are further arranged into multiple rows to create a frame block. In some implementations, the frame blocks are arranged between three rows and sixteen rows. In some implementations, a frame block may be arranged from three rows of three frames to twelve rows of twelve frames. In some implementations, a frame block is arranged in eight rows of twelve battery cell holding frames. In some implementations, the frame blocks are further arranged into modular battery frames. In some implementations, the modular battery frame is constructed of multiple frame blocks. Any number of battery frame blocks may be combined to create modular battery frames of any size.

Each modular battery frame is constructed of frame blocks attached to scaffolds. Each frame block is further constructed of several components. The modular battery frames are constructed around battery cells. The frame blocks are constructed of battery cell frames connected together to hold any desired number of battery cells 115. In some implementations, the frame blocks are designed with between two (2) and two-hundred and fifty-six (256) battery cell holding frames. The battery cells are connected together by collectors. Each battery cell connects to the collectors, and the collectors aggregate the battery cells. The manner in which the battery cells are aggregated along with the number of battery cells in the modular battery frame determines the capacity and voltage of the battery module. For battery modules containing a specific number of battery cells, aggregating the battery cells in parallel will increase the capacity of the battery module, while aggregating the battery cells in series will increase the voltage of the battery module. In some implementations, the battery cells are aggregated in in one manner for a smaller subset of the battery cells and then that smaller subset of battery cells is aggregated in a different manner. For example, a row of battery cells is aggregated in parallel, and then each row is aggregated in series. The resultant frame blocks could then be aggregated in series or in parallel. The frame blocks of the modular battery frames can be constructed in myriad options. Then the frame blocks are connectable in myriad options. Each modular battery frame is then connectable to other modular battery frames in myriad options. Thus, the options for creating a battery pack are multitudinous. The modularity of the modular battery frames enables the modular battery frame to be constructed to any desired specifications. This means that the modular battery frame are capable of being designed and configured to fit in places where other batteries or battery packs could not fit.

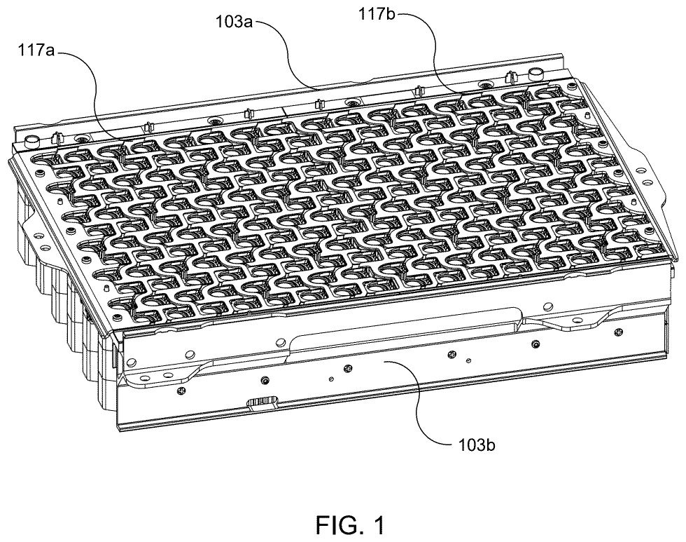

Now referring to FIG. 1, which is a top view of a modular battery frame 101. The modular battery frame 101 includes two frame blocks 117a and 117b. The frame blocks 117a and 117b, attach to scaffolds 103a and 103b. The terminals 118a and 118b connect to the connected collectors.

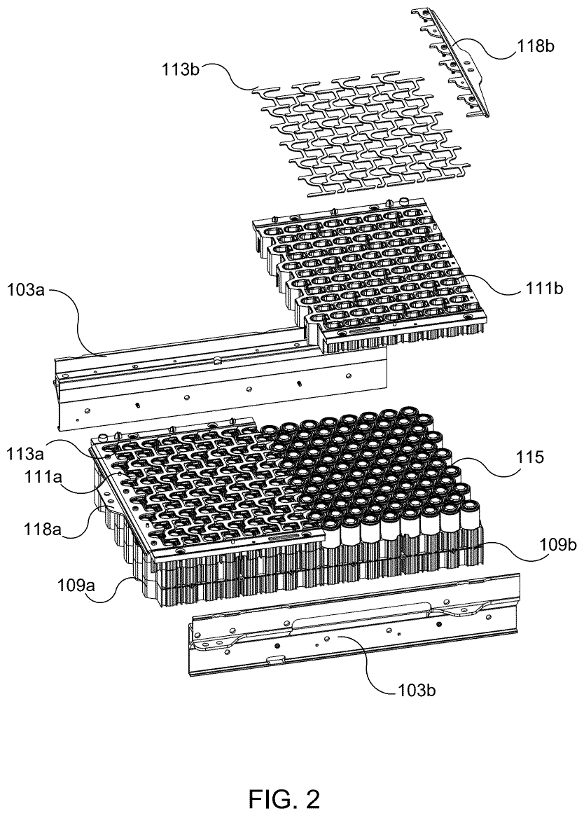

Each modular battery frame is constructed of frame blocks attached to scaffolds. Each frame block is further constructed of several components. FIG. 2 is an exploded view of a battery module. The modular battery frame 101 is constructed around the battery cells 115. The frame blocks such as frame block 117a are constructed of battery cell frames connected together to hold any desired number of battery cells 115. In some implementations, the frame blocks are designed with between two (2) and two-hundred and fifty-six (256) battery cell holding frames. In some implementations, such as that depicted in FIG. 2, the frame blocks such as frame block 117a are designed with ninety-six battery cell holding frames. In this implementation, the battery-cell holding frames are arranged in twelve rows of eight battery-cell holding frames. The frame blocks include lower portions 109a and 109b which hold and secure the base of the battery cells. The lower portions are connected to a base (not shown). Battery cells are inserted into the lower portions 109a and 109b, with the bottom of the battery cells in the lower portions.

The frame blocks also include upper portions 111a and 111b. The upper portions 111a and 111b, of each of the frame blocks secure the top of each battery cell. The upper portions 111a and 111b, of the frame blocks also include a rigid top. The rigid top increases the stability of the frame blocks. Set into the rigid top are channels for holding collectors 113a and 113b. The collectors are electrical conduits to which the battery cells are connected. The collectors 113a and 113b are the connections between the battery cells and establish how the battery cells are aggregated. The collectors 113a and 113b, that fit in the channels of the rigid top are configurable to fit the needs of the desired battery pack. Changing the configuration of the collectors changes the characteristics of the battery pack. Aggregating the battery cells in series will increase the voltage, while aggregating the battery cells in parallel will increase the capacity. In some implementations, the collectors are designed to aggregate all the battery cells in a frame block in series. In some implementations, the collectors aggregate each battery cell in a row in series and aggregate the rows in parallel. In some implementations the battery cells in a row are aggregated in parallel and each row is aggregated in series. In this way, the voltage and capacity are modifiable.

The upper portions 111a and 111b and lower portions 109a and 109b of the frame blocks house battery cells, therefore the upper and lower portions should be constructed of materials that are electrically inert. By constructing the upper and lower portions of electrically inert materials it lessens the possibility of fire and shorting out of the battery module. In some implementations, the upper and lower portions are manufactured of plastic. Such plastics include polytetrafluoroethylene (PTFE), polypropylene (PP), high-density polyethylene (HDPE), acrylonitrile butadiene styrene (ABS), and other polymers.

In some implementations, multiple frame blocks are mechanically connected and the battery cells in each frame block are electrically connected. Each frame block mechanically connects to scaffolds 103a and 103b. The scaffolds are shared structural members. The scaffolds provide structure to the modular battery frames. The scaffolds add rigidity to the modular battery frame. By securing the frame blocks to the scaffolds, the frame blocks become an integrated unit, a modular battery frame. As an integrated unit the modular battery frame can be picked up and moved to different locations. Thus, the modular battery frame is modifiable in its construction and is modifiable in the locations in which it can be used. In some implementations, between two and twenty frame blocks are connected to the scaffolds. The scaffolds are manufactured to the size necessary to accommodate the determined number of frame blocks. In some implementations, such as those depicted in FIG. 1 and FIG. 2, two frame blocks 117a and 117b are packaged together. For the depicted implementation, the scaffolds 103a and 103b are manufactured to accommodate six frame blocks. The scaffolds provide structure to the modular battery frame; therefore, the scaffolds are constructed of materials that are strong enough to provide the structure for the modular battery frame. In some implementations, the scaffolds are made from plastic. Such plastics include polytetrafluoroethylene (PTFE), polypropylene (PP), high-density polyethylene (HDPE), acrylonitrile butadiene styrene (ABS), and other polymers. In some implementations, the plastic is reinforced. Such reinforced plastics include fiberglass reenforced nylon, fiberglass reinforced copolymers, and other reinforced polymers. In some implementations, the scaffolds are made from carbon fiber. In some implementations, the scaffolds are made from metal. Such metals include aluminum, anodized aluminum, titanium, anodized titanium, magnesium, steel, and stainless steel. In embodiments which utilize metal in the construction of the scaffolds, the scaffolds are grounded.

In some implementations, the frame blocks 117a and 117b attach to the scaffolds 103a and 103b with fasteners. In some implementations, the fasteners are manufactured into the scaffolds. Such manufactured fasteners include hooks or buttons which secure into apertures or keyholes. In some implementations, the fasteners are screws or rivets. The fastener 119 attaches to the frame block.

The battery cell holding frames are hexagonal in shape. The hexagonal shape enables an effective packing of the battery cells in the battery cell holding frames. The arrangement of the hexagonal battery cell holding frames confines the arrangement of the battery cell holding frames. The hexagonal shape establishes the battery cell holding frames in straight rows. Adjacent rows are offset from the neighboring rows. The odd numbered rows will be aligned, and the even numbered rows will be aligned. The hexagonal shape also imparts strength to the modular battery cell frame.

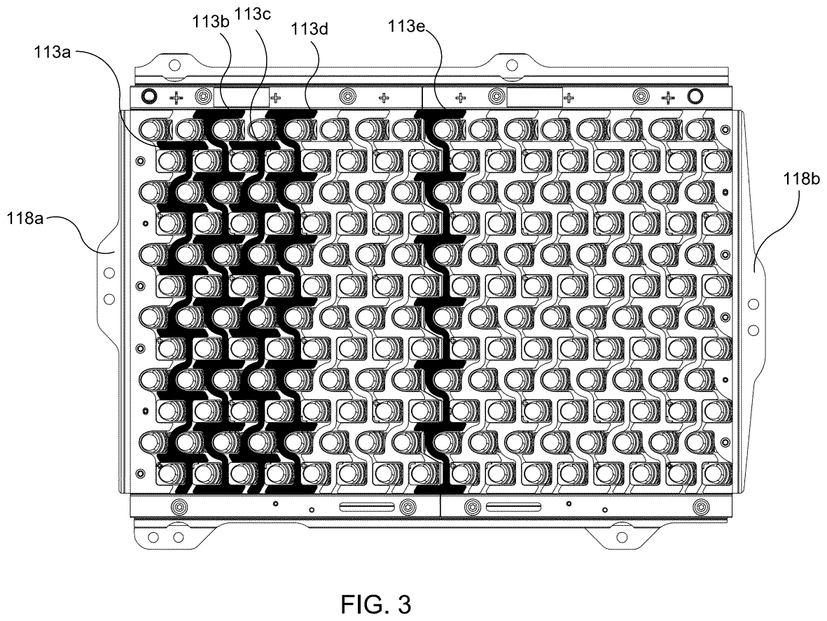

Referring now to FIG. 3 which is a top view of a modular battery frame with battery cells installed. The modular battery frame is composed of multiple frame blocks such as frame blocks 117a and 117b. The collectors such as collector 113a, 113b, 113c, 113d, and 113e aggregate the battery cells. In the embodiment of FIG. 3, each collector aggregates a battery from each row. In describing the locations of parts of the modular frame such as the battery cells, the numbering progresses from left to right, and from top to bottom. For example, collector 113a aggregates each of the first battery cell from each of the twelve rows. Collector 113b aggregates each of the second battery cells in each of the twelve rows. Collector 113c aggregates each of the third battery cells in each of the twelve rows of battery cells. Collector 113d aggregates each of the fourth battery cells in each of the twelve rows. Collector 113e aggregates each of the eighth battery cells in each of the twelve rows. The collectors connect together. For example, collector 113a connects to collector 113b, which connects to collector 113c, and the collectors continue to connect together until all the collectors are connected. Additionally, collector 113e bridges the gap between the frame block 117a and the frame block 117b. The terminals 118a and 118b connect to the connected collectors. The connection of the collectors together and the ability of the collectors to bridge the gaps between each frame block enables efficient construction of differently sized battery modules. With the ability of the collectors to bridge frame blocks and connect the battery cells of one frame block to the battery cells of another frame block, each frame block is connected by a collector and does not require the terminal of one frame block to connect to the terminal of another frame block. The ability of the collectors to bridge the gaps between adjacent frame blocks makes the battery modules a continuous collection of battery cells. By eliminating the necessity to connect terminals together to have battery modules and batteries of differing voltages and capacities, the manufacture of battery modules and batteries is more efficient. The efficiency is increased both in construction time and in construction materials. Also, the use of collectors to connect frame blocks reduces the potential failure points of the battery module. A terminal-to-terminal connection has more points of failure than the connection of collector to collector.

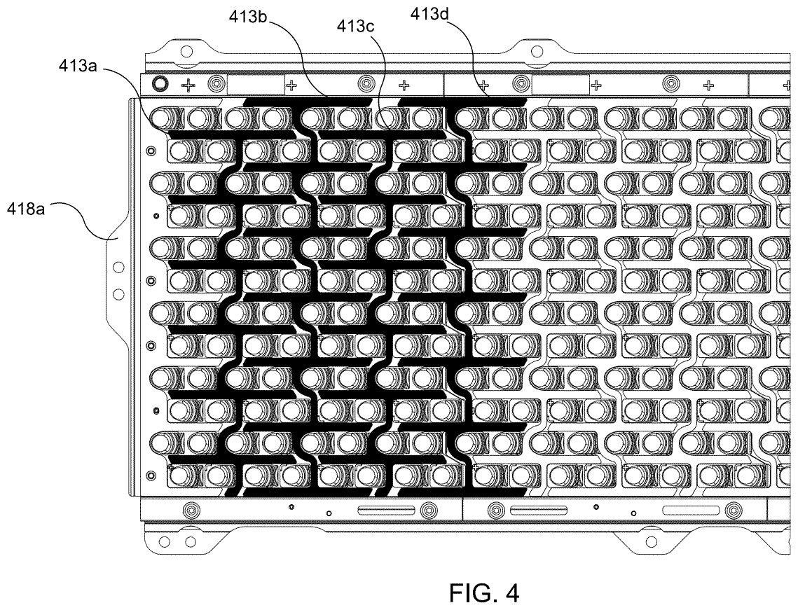

Referring now to FIG. 4 which is a top view of a modular battery frame with battery cells installed. The modular battery frame is composed of multiple frame blocks such as frame blocks 417a and 417b. The collectors such as collector 413a, 413b, 413c, and 413d aggregate the battery cells. In describing the locations of parts of the modular frame such as the battery cells, the numbering progresses from left to right, and from top to bottom. In the embodiment of FIG. 4, each collector aggregates two battery cells from each row. For example, collector 413a aggregates the first and second battery cells from each of the twelve rows. Collector 413b aggregates the third and fourth battery cells in each of the twelve rows. Collector 413c aggregates the fifth and sixth battery cells in each of the twelve rows of battery cells. Collector 413d aggregates the seventh and eighth battery cells in each of the twelve rows. collectors connect together. For example, collector 413a connects to collector 413b, which connects to collector 413c, and the collectors continue to connect together until all the collectors are connected. Additionally, collector 413d bridges the gap between the frame block 417a and the frame block 417b. The terminals 418a and 418b connect to the connected collectors.

Configuring the battery cells in different aggregates results in battery packs with different voltages and different capacities. Table 1 gives multiple options for the different possible configurations.

TABLE 1

| S- | P- | VOLTAGE | CAPACITY | Energy |
|---|---|---|---|---|
| COUNT | COUNT | (V) | (Ah) | (kWh) |
| 48 | 12 | 172.8 | 60 | 10.4 |
| 24 | 24 | 86.4 | 120 | 10.4 |
| 16 | 36 | 57.6 | 180 | 10.4 |
| 12 | 48 | 43.2 | 240 | 10.4 |
| 8 | 72 | 28.8 | 360 | 10.4 |
| 24 | 12 | 86.4 | 60 | 5.2 |
| 36 | 15 | 129.6 | 75 | 9.7 |

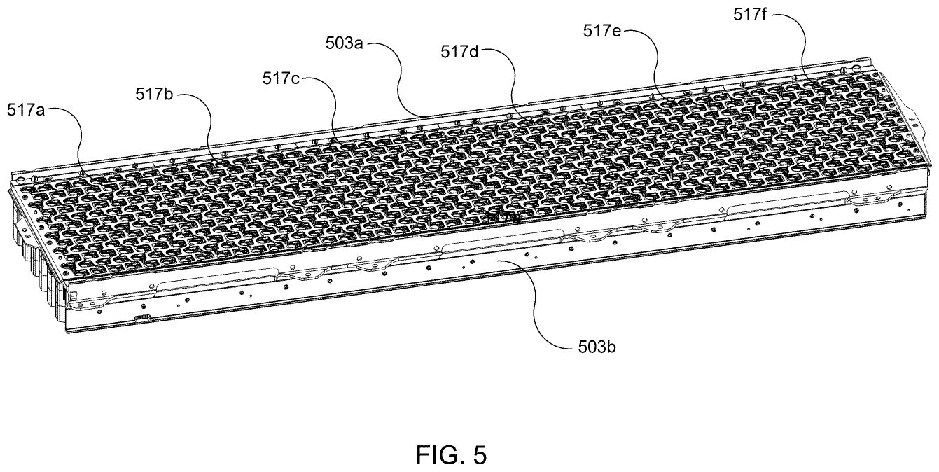

Now referring to FIG. 5, which is a top view of a modular battery frame 501. The modular battery frame 501 includes six frame blocks 517a, 517b, 517c, 517d, 517e, and 517f. The frame blocks 517a, 517b, 517c, 517d, 517e, and 517f attach to scaffolds 503a and 503b.

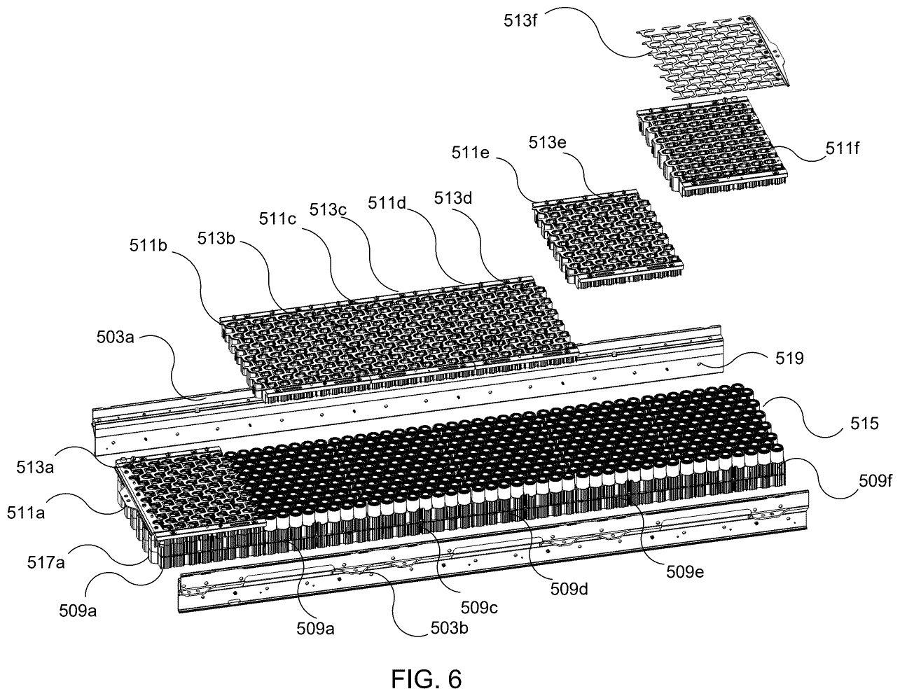

Each modular battery frame is constructed of frame blocks attached to scaffolds. Each frame block is further constructed of several components. FIG. 6 is an exploded view of a battery module. The modular battery frame 501 is constructed around the battery cells 515. The frame blocks such as frame block 517a are constructed of battery cell frames connected together to hold any desired number of battery cells 515. In some implementations, the frame blocks are designed with between two (2) and two-hundred and fifty-six (256) battery cell holding frames. In some implementations, such as that depicted in FIG. 2, the frame blocks such as frame block 517a are designed with ninety-six battery cell holding frames. In this implementation, the battery-cell holding frames are arranged in twelve rows of eight battery-cell holding frames. The frame blocks include lower portions 509a, 509b, 509c, 509d, 509e, and 509f which hold and secure the base of the battery cells. The lower portions are connected to a base (not shown). Battery cells are inserted into the lower portions 509a, 509b, 509c, 509d, 509e, and 509f, with the bottom of the battery cells in the lower portions.

The frame blocks also include upper portions 511a, 511b, 511c, 511d, 511e, and 511f. The upper portion 511a, 511b, 511c, 511d, 511e, and 511f of each of the frame blocks secure the top of each battery cell. The upper portions 511a, 511b, 511c, 511d, 511e, and 511e of the frame blocks also include a rigid top. The rigid top increases the stability of the frame blocks. Set into the rigid top are channels for holding collectors 513a, 513b, 513c, 513d, 513e, and 513f. The collectors are electrical conduits to which the battery cells are connected. The collectors 513 are the connections between the battery cells and establish how the battery cells are aggregated. The collectors 513a, 513b, 513c, 513d, 513e, and 513f that fit in the channels of the rigid top are configurable to fit the needs of the desired battery pack. Changing the configuration of the collectors changes the characteristics of the battery pack. Aggregating the battery cells in series will increase the voltage, while aggregating the battery cells in parallel will increase the capacity. In some implementations, the collectors are designed to aggregate all the battery cells in a frame block in series. In some implementations, the collectors aggregate each battery cell in a row in series and aggregate the rows in parallel. In some implementations the battery cells in a row are aggregated in parallel and each row is aggregated in series. In this way, the voltage and capacity are modifiable.

The upper portions 511a, 511b, 511c, 511d, 511e, and 511f and lower portions 509a, 509b, 509c, 509d, 509e, and 509f of the frame blocks house battery cells, therefore the upper and lower portions should be constructed of materials that are electrically inert. By constructing the upper and lower portions of electrically inert materials it lessens the possibility of fire and shorting out of the battery module. In some implementations, the upper and lower portions are manufactured of plastic. Such plastics include polytetrafluoroethylene (PTFE), polypropylene (PP), high-density polyethylene (HDPE), acrylonitrile butadiene styrene (ABS), and other polymers.

In some implementations, multiple frame blocks are mechanically connected and the battery cells in each frame block are electrically connected. Each frame block mechanically connects to scaffolds 503a and 503b. The scaffolds are shared structural members. The scaffolds provide structure to the modular battery frames. The scaffolds add rigidity to the modular battery frame. By securing the frame blocks to the scaffolds, the frame blocks become an integrated unit, a modular battery frame. As an integrated unit the modular battery frame can be picked up and moved to different locations. Thus, the modular battery frame is modifiable in its construction and is modifiable in the locations in which it can be used. In some implementations, between two and twenty frame blocks are connected to the scaffolds. The scaffolds are manufactured to the size necessary to accommodate the determined number of frame blocks. In some implementations, such as that depicted in FIG. 5 and FIG. 6, six frame blocks 517a, 517b, 517c, 517d, 517e, and 517f are packaged together. For the depicted implementation, the scaffolds 503a and 503b are manufactured to accommodate six frame blocks. The scaffolds provide structure to the modular battery frame; therefore, the scaffolds are constructed of materials that are strong enough to provide the structure for the modular battery frame. In some implementations, the scaffolds are made from plastic. Such plastics include polytetrafluoroethylene (PTFE), polypropylene (PP), high-density polyethylene (HDPE), acrylonitrile butadiene styrene (ABS), and other polymers. In some implementations, the plastic is reinforced. Such reinforced plastics include fiberglass reenforced nylon, fiberglass reinforced copolymers, and other reinforced polymers. In some implementations, the scaffolds are made from carbon fiber. In some implementations, the scaffolds are made from metal. Such metals include aluminum, anodized aluminum, titanium, anodized titanium, magnesium, steel, and stainless steel. In embodiments which utilize metal in the construction of the scaffolds, the scaffolds are grounded.

In some implementations, the frame blocks 517a, 517b, 517c, 517d, 517e, and 117f attach to the scaffolds 503a and 503b with fasteners. In some implementations, the fasteners are manufactured into the scaffolds. Such manufactured fasteners include hooks or buttons which secure into apertures or keyholes. In some implementations, the fasteners are screws or rivets. The fastener 519 attaches to the frame block.

The battery cell holding frames are hexagonal in shape. The hexagonal shape enables an effective packing of the battery cells in the battery cell holding frames. The arrangement of the hexagonal battery cell holding frames confines the arrangement of the battery cell holding frames. The hexagonal shape establishes the battery cell holding frames in straight rows. Adjacent rows are offset from the neighboring rows. The odd numbered rows will be aligned, and the even numbered rows will be aligned. The hexagonal shape

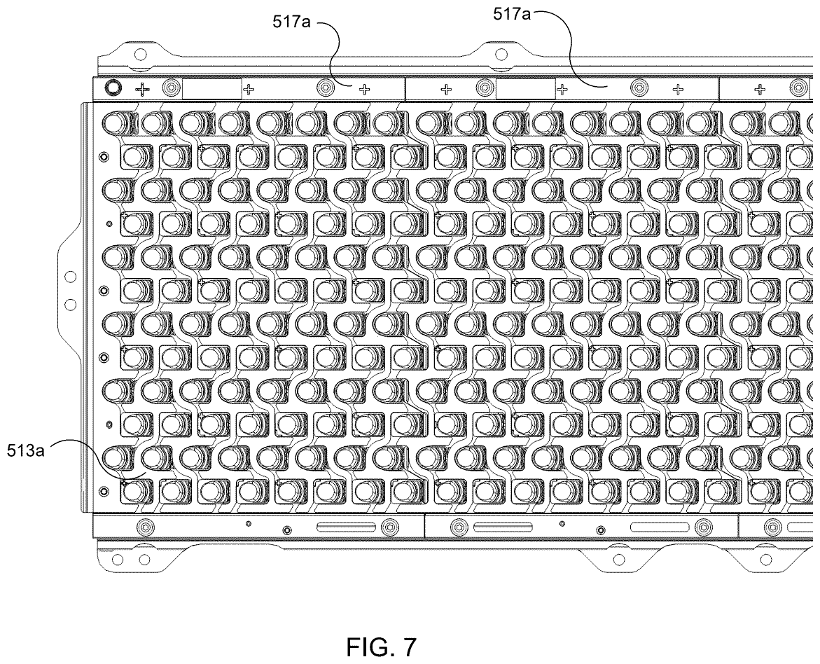

Referring now to FIG. 7 which is a top view of a modular battery frame with battery cells installed. The modular battery frame is composed of multiple frame blocks such as frame blocks 517a and 517b. The collectors such as collector 513a aggregate the battery cells.

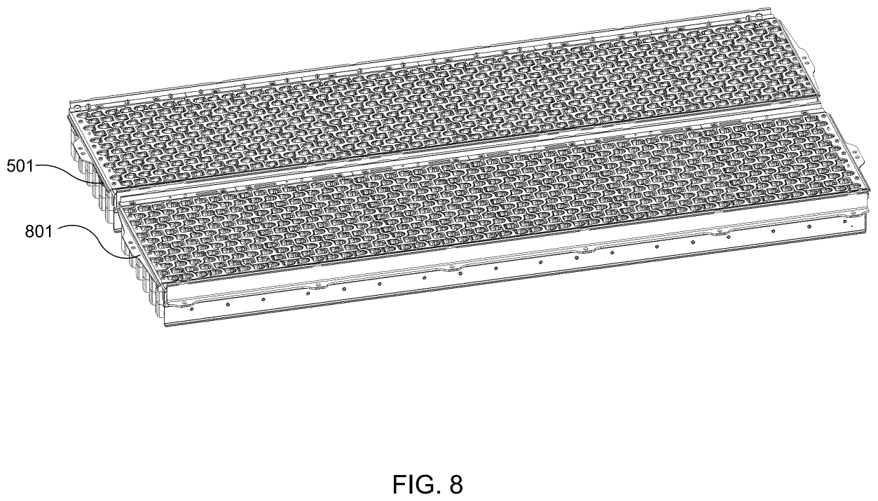

One advantage of the modular battery frame is the potential to easily modify the size of the frame blocks, the number of frame blocks, and the way the battery cells are aggregated together to modify the voltage and/or capacity of the battery module. In addition to modifying the components of each modular battery frame and therefore each battery module, the modular battery frames are configured to enable them to be joined to further modify the voltage and/or capacity of a joined battery module. FIG. 8 depicts two modular battery frames 501 and 801 mechanically and electrically connected together. Each modular battery frame includes six frame blocks, modular battery frame 701 includes frame blocks 817a, 817b, 817c, 817d, 817e, and 817f. Scaffolds 803a and 803b attach to the frame blocks 817a, 817b, 817c, 817d, 817e, and 817f. Modular battery frame 801 includes frame blocks 817a, 817b, 817c, 817d, 817e, and 817f. Scaffolds 803a and 803b attach to the frame blocks 817a, 817b, 817c, 817d, 817e, and 817f.

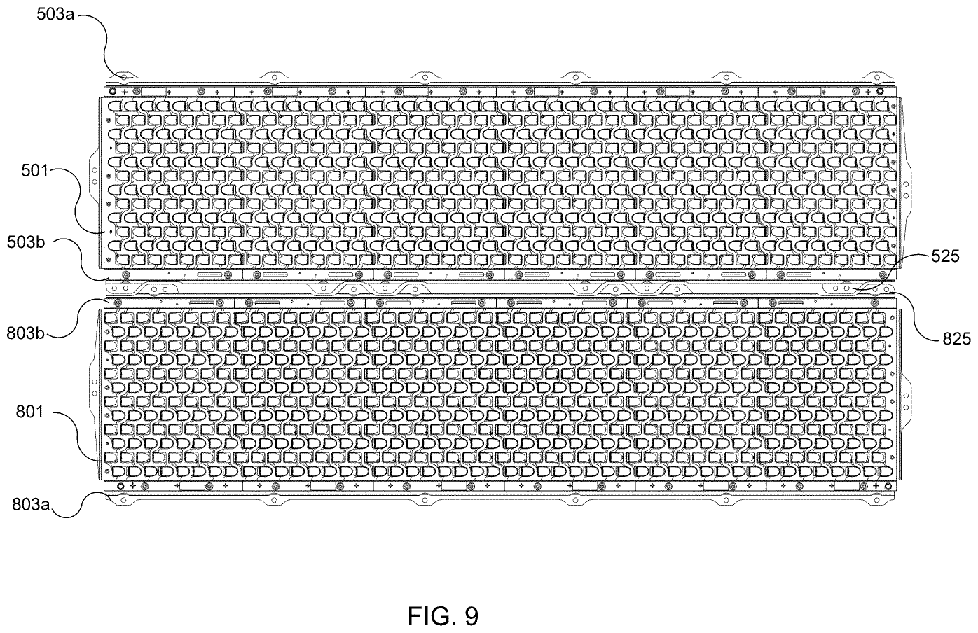

FIG. 9 is a top-down view of two modular battery frames 501 and 801. Each modular battery frame includes six frame blocks, modular battery frame 501 includes frame blocks 517a, 517b, 517c, 517d, 517e, and 517f. Scaffolds 503a and 503b attach to the frame blocks 517a, 517b, 517c, 517d, 517e, and 517f. Modular battery frame 801 includes frame blocks 817a, 817b, 817c, 817d, 817e, and 817f. Scaffolds 803a and 803b attach to the frame blocks 817a, 817b, 817c, 817d, 817e, and 817f. The scaffolds 503a and 503b of battery module 501 include castellations such as castellation 525. The scaffolds 803a and 803b of battery module 801 include castellations such as castellation 825. The castellations such as castellation 525 of scaffold 503b intersperse with castellations such as castellation 825 on scaffold 803b of the modular battery frame 801.

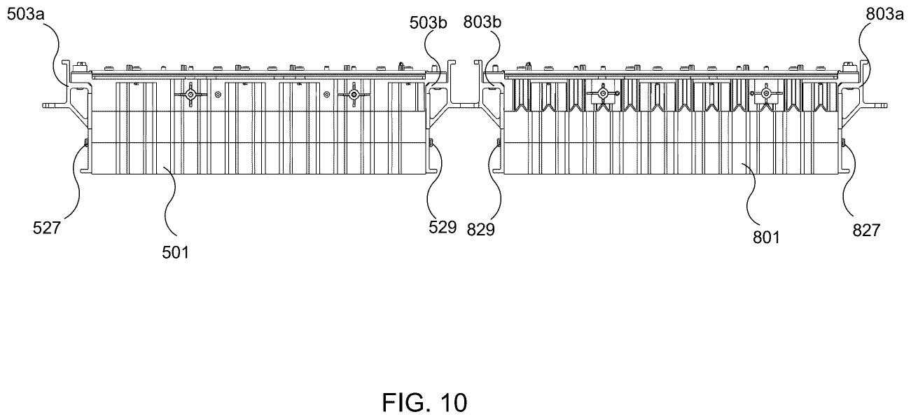

FIG. 10 is a front view of the modular battery frames 501 and 801. Scaffold 503a attaches to the frame blocks with fasteners such as fastener 527. Scaffold 503b attaches to the frame blocks with fastener 529. Scaffold 803a attaches to the frame blocks with fasteners such as fastener 827. Scaffold 403b attaches to the frame blocks with fastener 829.

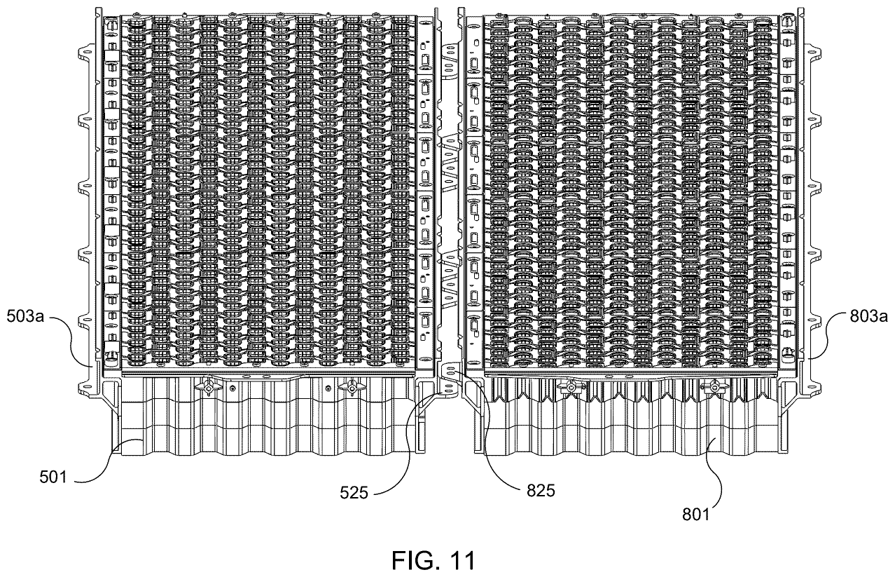

FIG. 11 is a front elevation view of modular battery frames 501 and 801. Each modular battery frame includes six frame blocks, modular battery frame 501 includes frame blocks 517a, 517b, 517c, 517d, 517e, and 517f. Scaffolds 503a and 503b attach to the frame blocks 517a, 517b, 517c, 517d, 517e, and 517f. Modular battery frame 801 includes frame blocks 817a, 817b, 817c, 817d, 817e, and 817f. Scaffolds 803a and 803b attach to the frame blocks 817a, 817b, 817c, 817d, 817e, and 817f. The scaffolds 503a and 503b of battery module 501 include castellations such as castellation 525. The scaffolds 803a and 803b of battery module 801 include castellations such as castellation 825. The castellations such as castellation 525 of scaffold 503b intersperse with castellations such as castellation 825 on scaffold 803b of the modular battery frame 801.

The invention has been described with reference to various specific and preferred embodiments and techniques. Nevertheless, it is understood that many variations and modifications may be made while remaining within the spirit and scope of the invention.

What is claimed is:

1. A modular battery frame comprising:
one or more frame blocks comprising:
individual battery cell frames connected to one another;
collectors to electrically connect battery cells;
scaffolds to which the frame blocks attach;
wherein the size of the modular battery is modifiable by changing the length of the scaffold profiles, to accommodate a predetermined number of frame blocks.

2. The modular battery frame of claim 1, wherein the frame blocks are modifiable.

3. The modular battery frame of claim 1, wherein the individual battery cell frames within each frame block are arranged in rows of between four and sixteen individual battery cell frames.

4. The modular battery frame of claim 3, wherein each frame block comprises between four and sixteen rows.

5. The modular battery frame of claim 4, wherein each frame block comprises eight rows of twelve individual battery cell frames.

6. The modular battery frame of claim 1, wherein the scaffolds attach to the frame blocks with fasteners.

7. The modular battery frame of claim 1, wherein the frame blocks attach to the scaffold profiles on a track system.

8. The modular battery frame of claim 1, wherein the collectors are configurable in multiple configurations.

9. The modular battery frame of claim 1, wherein a configuration of the collectors determines the voltage and capacity of a battery module.

10. A battery module comprising:
frame blocks comprising:
individual battery cell frames connected to one another;
collectors housed in the top;
battery cells in the individual battery cell frames and connect to the collectors;
scaffolds to which the frame blocks attach;
wherein the voltage and capacity of the battery module is modifiable by changing the length of the scaffold profiles.

11. The battery module of claim 10, wherein the capacity, voltage, and current of the battery module are configurable by modifying the connections between the battery cells.

12. The battery module of claim 10, wherein the voltage and capacity of the battery module are configurable by modifying the number of frame blocks in the battery module.

13. The battery module of claim 10, wherein the voltage and capacity of the battery module are configurable by modifying the manner in which the battery cells are aggregated.

14. A method for producing a battery module comprising:
providing a battery module frame comprising:
frame blocks comprising:
individual battery cell frames connected to one another;
collectors to electrically connect to and aggregate battery cells,
placing battery cells in the individual battery cell frames;
connecting the individual battery cells to the collectors;
connecting the frame blocks to scaffolds;
determining a capacity, current, and voltage for the battery module;
connecting the appropriate number of frame blocks together to provide the desired capacity, and voltage.

15. The method of claim 14, further comprising modifying the collectors to provide the desired capacity, and voltage.

16. The method of claim 14, wherein the individual battery cell frames within each frame block are arranged in rows of between four and sixteen individual battery cell frames.

17. The method of claim 16, wherein each frame block comprises between four and sixteen rows.

18. The method of claim 17, wherein each frame block comprises twelve rows of eight individual battery cell frames.

19. The method of claim 14, further comprising manufacturing the scaffold profiles in lengths to correspond to a set number of frame blocks.

20. The method of claim 14, further comprising determining a specific capacity and voltage of a battery module, assembling the determined number of individual batter cell frames into frame blocks, inserting battery cells into the frame blocks, connecting the necessary number of frame blocks to scaffolds, and connecting the appropriate collectors to properly aggregate the battery cells to reach the determined capacity and voltage of a battery module.
